(19) United States
(12) Patent Application Publication
(10) Pub. No.: US 2004/0098354 A1
(43) Pub. Date: May 20, 2004

(54) Method and system for conveying funds and secure information between secure devices

(75) Inventor: Flavio M. Manduley, Woodbury, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/295,673

(22) Filed: Nov. 15, 2002

(51) Int. Cl. G06F 17/00; H04L 9/00; G07B 17/02

(52) U.S. Cl. 705/401; 902/2; 713/200

(57) ABSTRACT

Postal metering systems with an external communication link which allows funds to be transferred from one postal metering system to another. The external communication link is provided between the safekeeping device of a first postal metering system to the secure communication device of a second postal metering system so that funds can be transferred through the external communication link from the second metering system from its secure communication device to the safekeeping device of the first postal metering system. Furthermore, when the safekeeping device also stores secure information, secure information can be transferred from the second metering system to the first metering system in the same manner. The safekeeping device and the secure communication device are commonly known as the postal secure device (PSD) and the gatekeeper.

### TECHNICAL FIELD

The present invention relates generally to secure devices such as postal meters and, more particularly, to transferring funds or other information between security devices.

### BACKGROUND OF THE INVENTION

Presently, there are two postal metering device types: a dosed system and an open system. In a closed system, the system functionality is solely dedicated to metering activity. The dosed-system metering devices are also referred to as postage-evidencing devices, which include conventional digital and analog (mechanical and electronic) postal meters, wherein a dedicated printer is securely coupled to a metering or accounting function. Furthermore, the printer is securely coupled and dedicated to the meter, and printing evidence of postage cannot take place without accounting for the evidence. In an open system, the printer is not dedicated to the metering activity, thereby freeing system functionality for multiple and diverse uses in addition to the metering activity. Examples of open system metering devices include personal-computer (PC) based devices with single/multi-tasking operating systems, multi-user applications and digital printers. An open-system metering device is a postage evidencing device with a non-dedicated printer that is not securely coupled to a secure accounting module. An open-system indicium printed by the non-dedicated printer is made secure by including addressee information in the encrypted evidence of postage printed on the mailpiece for subsequent verification. See U.S. Pat. Nos. 4,725,718 and 4,831,555, each assigned to the assignee of the present invention.

The United States Postal Service (USPS) has published draft specifications for IBIP (Information Based Indicia Program). These specifications define the proposed requirements for a Postal Security Device (PSD). A PSD is a secure processor-based accounting device that dispenses and accounts for postal value stored therein to support the creation of a new information-based postage postmark or indicium that will be applied to a mailpiece being processed using IBIP. The IBIP Specifications define a stand-alone, open-metering system, referred to herein as a PC Meter. The PC Meter comprises a PSD coupled to a Host PC, which is a personal computer (PC) operating as a host system with a printer coupled thereto. The Host PC runs the metering application and communicates with one or more attached PSD's. The PC Meter can only access PSD's coupled to the Host PC. There is no remote PSD access for the PC Meter.

The PC Meter processes transactions for dispensing postage, registration and refills on the Host PC. Processing is performed locally between the Host PC and the PSD coupled thereto. Connections to a Data Center, for example, for registrations and refill transactions, are made locally from the Host PC through a local or network modem/internet connection. Accounting for debits and credits to the PSD is also performed locally, logging the transactions on the Host PC. The Host PC may accommodate more than one PSD, for example, supporting one PSD per serial port.

One version of a network metering system, referred to herein as a virtual postal metering system, has many Host PCs without any PSD's coupled thereto. The Host PCs run Host Applications, but all PSD functions are performed by server(s) located at a Data Center. The PSD functions at the Data Center may be performed in a secure device attached to a computer at the Data Center, or may be performed in the Data Center computer itself. The Host PCs must connect with the Data Center to process transactions such as postage dispensing, meter registration, or meter refills. Transactions are requested by the Host PC and are sent to the Data Center for remote processing. The transactions are processed centrally at the Data Center, and the results are returned to the Host PC. Accounting for funds and transaction processing is centralized at the Data Center (See, for example, U.S. Pat. Nos. 4,873,645 and 5,454,038, which are assigned to the assignee of the present invention). Typically, when a user makes a request via the Host PC to a Data Center for proof of postage payment for a mailpiece, the Host PC sends a group of standard mailing parameters, such as the user's full address and amount of postage requested, to the Data Center. After validating the user and the account balance, the Data Center uses the PSD to issue a digital signature/token based on the provided standard mailing parameters and sends the digital signature to the postal meter or printer so that the meter or the printer can print an indicium on the mailpiece as proof of postage payment.

In U.S. Pat. Nos. 4,873,645 and 5,454,038, a virtual postal metering system and method are disclosed, wherein the postal accounting and token generation occur at a data center remote from the postage-evidencing printer. Although the Data Center may be a secure facility, there remain certain inherent security issues since the accounting and token generation functions do not occur in a secure device local to the postage printer. The virtual postal metering system includes a computer coupled to an unsecured printer and to a remote data metering system. The postal accounting and the token generation occur at the Data Center. The Data Center is a centralized facility under the control of a meter vendor, such as Pitney Bowes, or the Postal Service. As such, it is regarded as secure compared to the environment where mailers handle meters directly.

Presently, in a closed system, a postal meter is unidirectional in that the funds are loaded at the Data Center and the fund balance is deducted every time an indicium is printed. In an open system, the fund is stored in the PSD but it must be loaded through the Data Center. In a sense, such an open metering system is also a unidirectional device. In a virtual postal metering system as described above, the PSD functions are performed by servers at the Data Center. Thus, in prior art, the transfer of funds to a postal meter, regardless of the meter type, must be carried out through a Data Center to which the postal meter is operatively coupled, as shown in FIG. 1. The prior art postal meter 1, as shown in FIG. 1, comprises a user interface 10, a control logic unit 20, an input/output communication logic unit 30, a PSD 40, a gatekeeper 50 and a printing mechanism 60. The user interface 10 allows a customer to specify the postage amount of the indicium to be printed. The control logic unit 20, upon receiving a signal from the user interface 10, notifies a PSD 40 of the specified postage amount. The PSD 40 checks to see whether the funds stored therein are sufficient to pay for the postage. If so, the PSD 40 sends a signal indicative of the indicium to the gatekeeper 50. When the user activates the postage meter 1 with a mailpiece on which the indicium is to be printed, a trip signal 82, via the control logic unit 20, causes the gatekeeper 50 to transfer the postage amount from the PSD 40 to the printing mechanism 60. Subsequently the requested indicium is printed. Whereas the PSD 40 keeps track of the funds stored in the postal meter 1 and authorizes a portion of the stored funds to be used for the postage indicium, the most important function of the gatekeeper 50 is to maintain a secure connection between the PSD 40 and the printing mechanism 60. It should be noted that prior to the advent of the digital postage meter, security in a mechanical meter was achieved by physically keeping the funds and printing within the same sealed box. Even after electronic meters became available in the market, the concept of security remains substantially unchanged. However, with digital postage meters, the funds and the printing are physically separated but connected by a cable. The cable must be secure so as to secure the funds in the digital postage meter. For that reason, the gatekeeper is implemented in a postal meter, not only to control and generate functions related to indicium printing, but also to keep the communication between the printing mechanism and the PSD secure. The input/output communication logic unit 30 allows the transfer of funds between a data center 80 and the postal meter 1. With the input/output communication logic unit 30, a customer uses the interface 10 to request the transfer of funds from the data center 80. The prior art system allows transfer of funds only between the data center and the postal meter 1.

Presently, it is not possible to transfer funds between two postal metering systems even if these metering systems are in the possession of the same individual or business entity. Thus, it is advantageous and desirable to provide a method and system for enabling one postal meter to transfer funds to another postal meter, or enabling one PSD to transfer funds or other information to others PSD's.

### SUMMARY OF THE INVENTION

It is an objective of the present invention to allow a postal metering system to receive funds from another postal metering system, in addition to receiving funds from a data center. This objective can be achieved by providing an external communication link between two postal metering systems.

Accordingly, the first aspect of the present invention is a method of transferring funds between postal metering systems, wherein at least a first postal metering system and a second postal metering system each comprises: a safekeeping device for storing and releasing funds; a secure communication device for ensuring that communications with the safekeeping device are secure; an input/output communication module, operatively connected to the safekeeping device, to allow funds to be transferred from a data center to the safekeeping device via the input/output communication module; and a control device, operatively connected to the secure communication device, for causing a release of funds by the safekeeping device through the secure communication device when the control device receives a request for said fund release. The method comprises the steps of: providing an external communication link from the first postal metering system to the second postal metering system; and transferring funds through the external communication link from the second postal metering system from its secure communication device to the safekeeping device of the first postal metering system.

Advantageously, the fund transfer through the external communication link is in response to a request made at the control device of the first postal metering system. The method further comprises the steps of: sending a request of said fund transfer through the external communication link, said request conveyed from the control device of the first postal metering system to the control device of the second postal metering system; and granting said request by the second postal metering system.

Advantageously, the method further comprises the steps of conveying a first signal from the control device of the second postal metering system to the control device of the first postal metering system indicative of said granting; and conveying a second signal from the control device of the first postal metering system to the control device of the second postal metering system acknowledging receipt of the first signal, thereby causing said fund transfer through the external communication link.

Alternatively, the fund transfer through the external communication link is in response to a request made at the control device of the second postal metering system, and the method further comprises the step of: conveying a first signal from the control device of the second postal metering system to the control device of the first postal metering system notifying said fund transfer through the external communication link; and conveying a second signal from the control device of the first postal metering system to the control device of the second postal metering system acknowledging receipt of the first signal, thereby causing said fund transfer through the external communication l ink.

Advantageously, the external communication link comprises a wireless communication link.

Advantageously, the postal metering systems further comprises at least a third metering system, which includes a safekeeping device for storing and releasing funds; and a secure communication device for ensuring that communications with the safekeeping device are secure. The method further comprises the steps of: providing a further external communication link from the second postal metering device to the third metering system; and transferring funds through the further external communication link from the second postal metering device from its secure communication device to the safekeeping device of the third metering system.

Advantageously, the safekeeping device also stores secure information and the control device is capable of causing a release of information by the safekeeping device through the secure communication device through the external communication link.

The second aspect of the present invention is a postal metering system comprising: a safekeeping device for storing and releasing funds; a secure communication device for ensuring that communications with the safekeeping device are secure; an input/output communication module, operatively connected to the safekeeping device, to allow funds to be transferred from a data center to the safekeeping device via the input/output communication module; and a control device, operatively connected to the secure communication device, for causing the safekeeping device to release funds through the secure communication device when the control device receives a request for said fund release, wherein the safekeeping device further comprises an external communication link so as to allow the postal metering system to receive funds from another postal metering system via the secure communication device thereof through the external communication link.

The third aspect of the present invention is a secure system, which comprises: a safekeeping device for storing and releasing secure information; a secure communication device for insuring communications with the safekeeping device are secure; an input/output communication module, operatively connected to the safekeeping device, to allow secure information to be transferred from a data center to the safekeeping device; and a control device, operatively connected to the secure communication device, for causing a release of secure information by the safekeeping device through the secure communication device upon receiving a request for said fund release, wherein the safekeeping device further comprises an external communication link so as to allow the secure system to receive secure information from another secure system via the secure communication device thereof through the external communication link.

The present invention will become apparent upon reading the description taken in conjunction with FIGS. 2 to 7.

### BRIEF DESCRIPTION OF THE DRAWINGS

FIG. 1 is a block diagram showing a prior art postal meter connected to a Data Center for transferring funds therebetween.

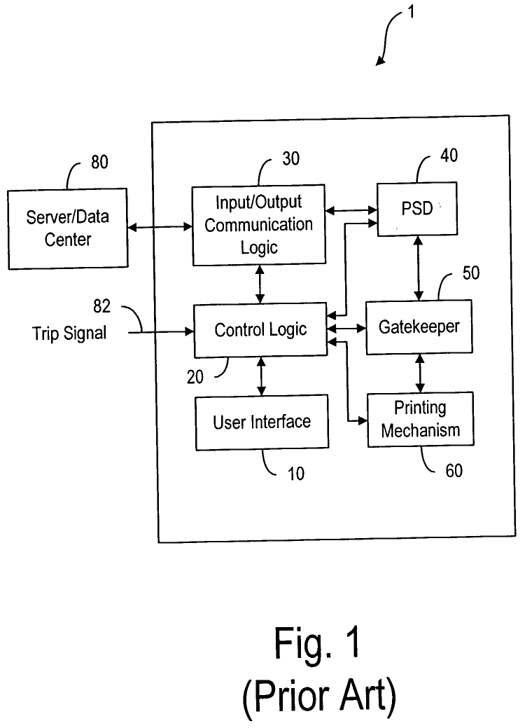

FIG. 2 is a block diagram showing a preferred postal meter system, according to the present invention.

FIG. 3a is a block diagram showing the connection between two postal metering systems, according to the present invention, for transferring funds from one system to another.

FIG. 3b is a block diagram showing the connections between two postal metering systems for transferring funds in a different fashion.

FIG. 4 is a block diagram showing a wire connection among a plurality of postal metering systems, according to the present invention.

FIG. 5 is a flowchart illustrating the method of secure fund transfer between a donor meter and a recipient meter, according to the present invention.

FIG. 6 is a block diagram showing the connection between two hand-held postal meters, according to the present invention, for transferring funds therebetween.

FIG. 7 is a block diagram showing a generalized secure system for transferring secure information, according to the present invention.

### BEST MODE FOR CARRYING OUT THE INVENTION

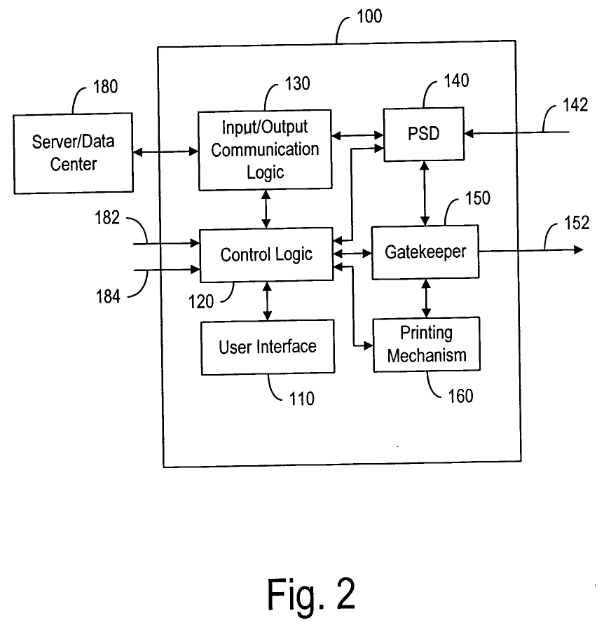

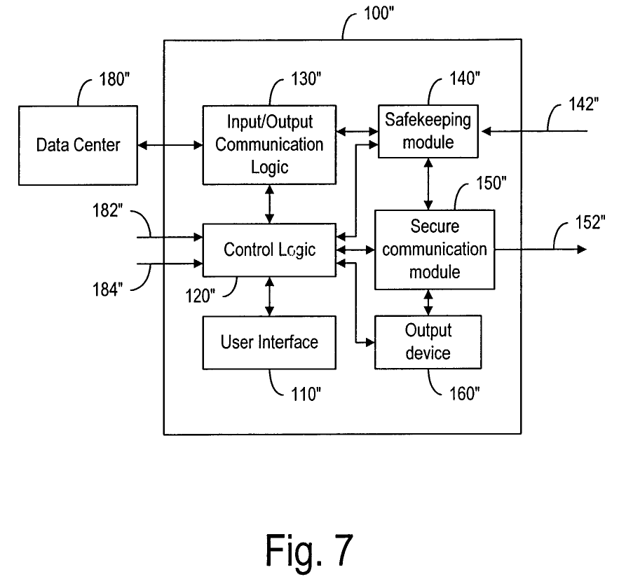

For illustration purposes, the present invention is described in conjunction with a postal metering system, as shown in FIGS. 2-6. However, the present invention is applicable to any secure device, as shown in FIG. 7.

Typically, the postal meter 100, according to the present invention, can be used to print postage indicia (not shown) to be used on mailpieces. As with the prior art postal meter 1, printing indicia upon request is a normal function of the meter 100. As shown in FIG. 2, the postal meter 100 comprises a user interface 110, a control logic unit 120, an input/output communication logic unit 130, a postal secure device (PSD) 140, a gatekeeper 150 and a printing mechanism 160. As with the prior art postal meter 1, the postal meter 100 can be linked to a data center 180 for transferring funds therebetween via the input/output communication logic unit 130. In contrast to the prior art postal meter 1, the control logic unit 120, the PSD 140 and the gatekeeper 150 are capable of communicating with other postal meters 100, via communication lines 184, 142 and 152, respectively. The signal line 182 is used to provide a trip signal when a customer activates the postal meter 100 by a mailpiece on which the requested indicium is printed.

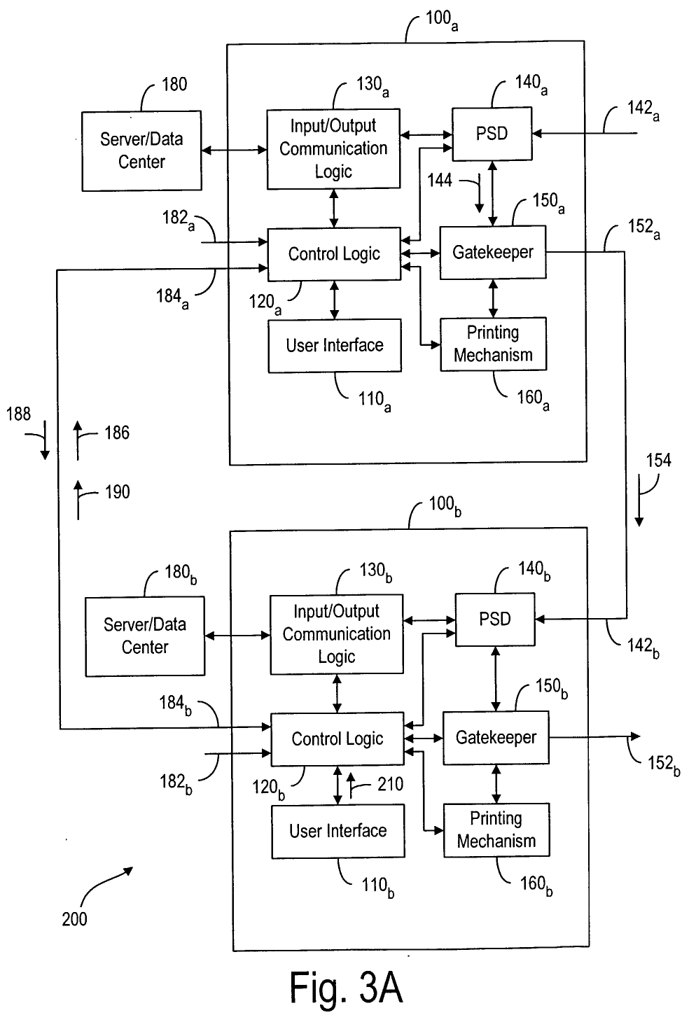

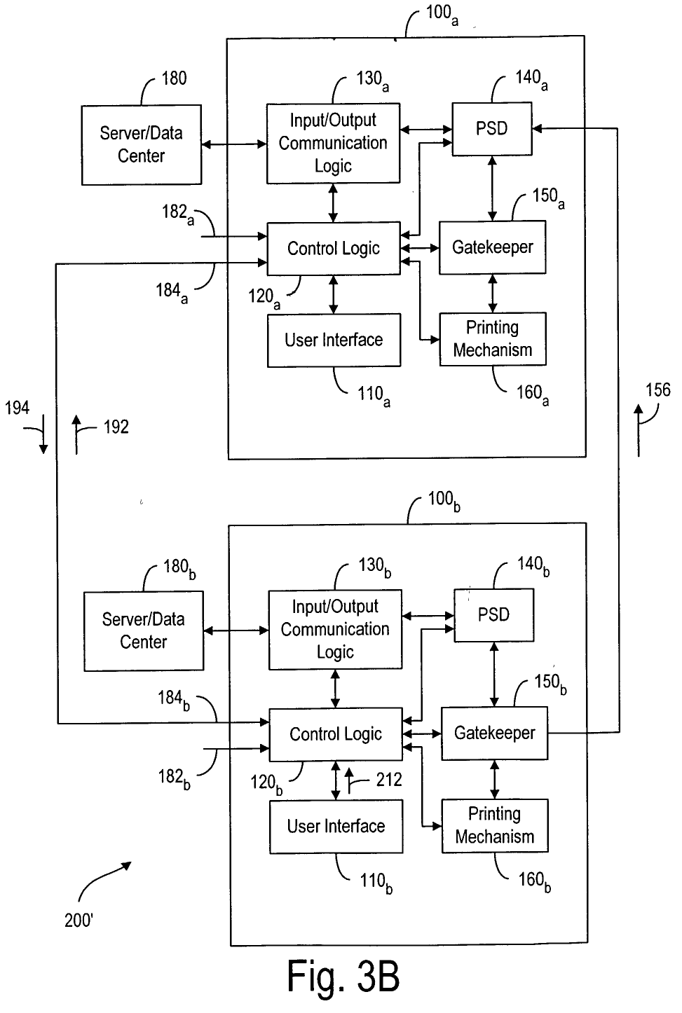

The gatekeeper 150, according to the present invention, is operatively connected between the PSD 140 and the printing mechanism 160 so as to maintain a secure connection therebetween regarding the printing of postage indicia. In addition, the gatekeeper 150 maintains a secure connection between the PSD 140 and an external device. More specifically, when the postal meter 100 is required to transfer funds out of the postal meter 100 to another postal meter, the gatekeeper 150 maintains a secure connection between the PSD 140 of the postal meter 100 and the PSD of the other postal meter, as shown in FIG. 3a.

FIG. 3a shows the connection between a postal meter 100ₐ and a postal meter 100_{b} in a system 200 so as to allow the postal meter 100ₐ to transfer funds to the postal meter 100_{b}. In this case, the postal meter 100ₐ is the donor meter and the postal meter 100_{b} is the recipient meter. For example, when a customer enters a request 210 through the user interface 110_{b} of the postal meter 100_{b}, the control logic unit 120_{b} determines whether the request 210 is for the normal function of indicium printing, or for the additional function of fund transfer. If it is a printing request, the postal meter 100_{b} carries out its normal function of indicium printing as described in conjunction with the prior art meter 1. If the request 210 is for transferring funds from postal meter 100ₐ to postal meter 110_{b}, the control logic unit 120_{b} sends a signal 186 via the signal line 184_{b} to the control logic unit 120ₐ requesting such a fund transfer. Upon receiving the fund transfer request 186 via the signal line 184ₐ, the control logic unit 120ₐ notifies the PSD 140ₐ of such request. The PSD 140ₐ checks to see whether there are sufficient funds stored therein for such a transfer and whether the fund transfer is authorized. Subsequently, the PSD 140ₐ sends a signal 144 indicative of the transferred funds to the gatekeeper 150ₐ. At the same time, the control logic 120ₐ notifies the control logic 120_{b} with a signal 188 that the request is granted. The control logic 120_{b} notifies the PSD 140_{b} that the requested funds are now available, and sends an acknowledgment signal 190 to the control logic 120ₐ. Similar to the trip signal 182ₐ, which causes the gatekeeper 150ₐ to transfer the postage mount from the PSD 140ₐ to the printing mechanism 160ₐ, the signal 190 causes the gatekeeper 150ₐ to transfer the funds 154 from the PSD 140ₐ to the PSD 140_{b}. Accordingly, the PSD 140_{b} stores the received funds 154 in the postal meter 100_{b} and the PSD 140ₐ reduces the stored funds therein.

Using a similar connection, the customer of the postal meter 100_{b} can also authorize a fund transfer from the postal meter 100_{b} to the postal meter 100ₐ by inputting a command 212 using the user interface 110_{b}, as shown in FIG. 3b. In this case, the control logic unit 120_{b} notifies the PSD 140_{b} and the control logic unit 120ₐ of such transfer. Upon receiving the signal 192, the control logic unit 120ₐ notifies the PSD 140ₐ of the forthcoming event. Subsequently, the control logic 120ₐ notifies the control logic 120_{b} via a signal 194 that the postal meter 100ₐ is ready to receive the transferred funds. The signal 194 causes the gatekeeper 150_{b} to release the authorized funds 156 from the PSD 140_{b} to the PSD 140ₐ.

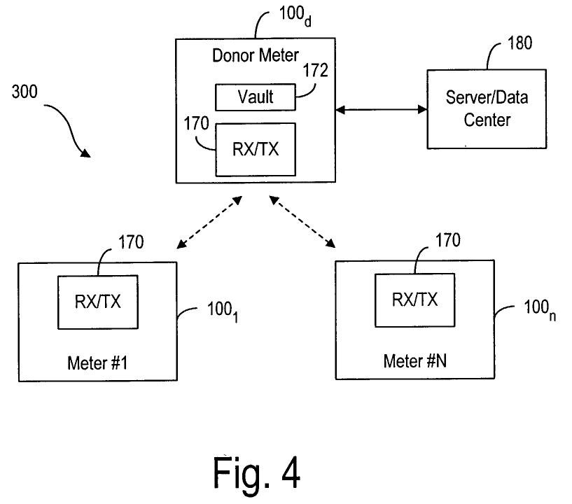

Wireless connection among a number of postal meters 100 is shown in FIG. 4. In the system 300, as shown in FIG. 4, a donor meter 100_{d} is adapted to receive funds from the data center 180 and acts as a distributor of funds to one or more postal meters 100₁, . . . , 100ₙ. Each of the postal meters 100_{d}, 100₁, . . . , 100ₙ comprises a transceiver 170, operatively connected to its control logic unit 120, PSD 140 and gatekeeper 150 so that it can communicate with other postal meters in a wireless fashion. Using the arrangement as shown in FIG. 4, the bulk of the funds can be stored in one vault in one meter to be distributed to other meters upon request. As shown, the funds are stored in the vault 172 in the donor postal meter 100_{d}. Funds can then be downloaded to any of the recipient postal meters 100₁, . . . , 100ₙ, in smaller amounts, from the donor postal meter 100_{d}. When funds are downloaded to a recipient postal meter 100ₙ from the donor postal meter 100_{d}, secure communication of funds is carried out from the gatekeeper 150 of the donor to the PSD 150 of the recipient, in a procedure similar to that described in conjunction with FIG. 3a. Advantageously, not all the postal meters need to store a large fund. Thus, the total amount of funds required for all postal meters is substantially reduced. As such, fund control and management can be improved. In the arrangement, as illustrated in FIG. 4, only one analog link (between the data center 180 and the donor postal meter 100_{d}) is required. This reduces the number of multiple analog lines necessary for the postal meters to communicate with the data center.

In the arrangement as shown in FIGS. 3a and 3b, any meter unit may act as donor or recipient. In the arrangement shown in FIG. 3a, the unit making the request can be referred to as the recipient unit or RU and the other unit can be referred to as donor unit or DU. An exemplary sequence for making a fund transfer request is summarized as follows:

1. User enters amount to be transferred to the RU.

2. User hits a request key.

3. The DU checks to make sure it has sufficient funds to transfer. If it does not have sufficient funds, it sends back a “not sufficient fund” signal and the operation is terminated. Otherwise the fund transfer is initiated. When the transfer is completed, the RU displays a “transaction completed”.

In this sequence, the operation is initiated at the RU by the user using the user interface. The signal input through the user interface is detected by the control logic, which checks through the RU gatekeeper for funds from the DU PSD. The DU PSD sends a granted or not granted signal to the RU through the DU control logic unit via the request line. If granted, the RU sends an acceptance signal via its user interface, control logic to the DU control logic, which notifies the DU PSD of the acceptance. Finally, the DU PSD sends funds through DU gatekeeper to RD PSD. All the activities described above involve the control logic units of both meters.

The connection between two postal meters 100ₐ and 100_{b}, as shown in FIGS. 3a and 3b, can be wired or wireless. For example, the postal meters 100ₐ and 100_{b} can be operatively connected to each other via a router or a server (not shown) in a local network of the Internet environment. Similarly, the postal meters 100ₐ and 100_{b} can be connected to each other via modems (not shown). Thus, the present invention is applicable to stand-alone systems as well as systems connected to the Internet or any communications network. Furthermore, the present invention uses the device known as Meter PSD as well as the infrastructure for remote funds and information downloading.

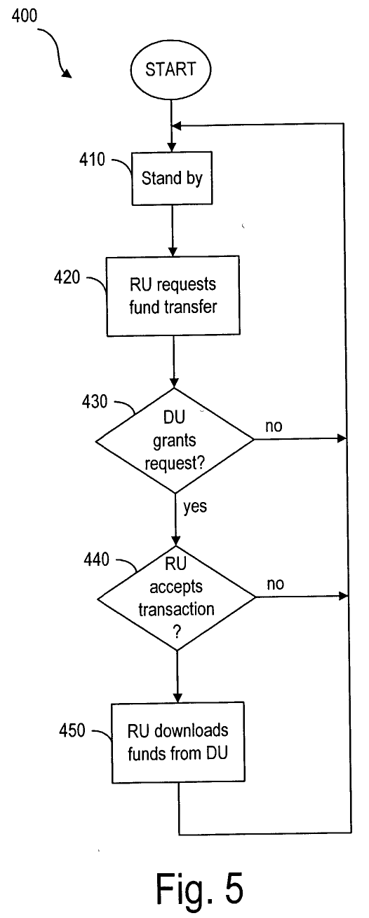

In the fund transfer process between a donor meter and a recipient, as described in conjunction with FIG. 3a, in particular, the process involves essentially three stages: 1) The recipient meter makes a request for fund transfer thereto; 2) the donor meter grants or denies the request, based on whether it has sufficient funds and whether the transfer is authorized, for example; and 3) the recipient accepts the granting or cancels the request, due to the request amount being entered erroneously, for example. Accordingly, the process can be illustrated in the flowchart as shown in FIG. 5. As shown, the process 400 comprises a standby mode at step 410 in which the donor meter does nothing but waits for a request to be initiated by a recipient meter, at step 420. The request can be represented by the signal 186 in FIG. 3a, for example. In response to the request, the donor meter checks to see whether it has sufficient funds to transfer and whether the requesting meter is authorized for such a transfer. If the answers are in the affirmative, the donor meter grants request of the recipient at step 430, and the process continues at step 440. Otherwise, the transaction is terminated and the process loops back to the standby mode 410. The granting message from the donor meter to the recipient meter can be represented by the signal 188 in FIG. 3a, for example. Upon receiving the granting message, the recipient meter has a choice to continue the process by accepting the funds to be transferred by the donor meter or to cancel the transaction. If the recipient meter decides to continue the process, it sends an acceptance signal to the donor meter. The acceptance signal can be represented by the signal 190 of FIG. 3a, for example. Subsequently, the donor meter, at step 450, transfers the request funds from its gatekeeper to the PSD of the recipient meter, as indicated by signal 154 of FIG. 3a. The transaction is now completed and the process loops back to the standby mode at step 410.

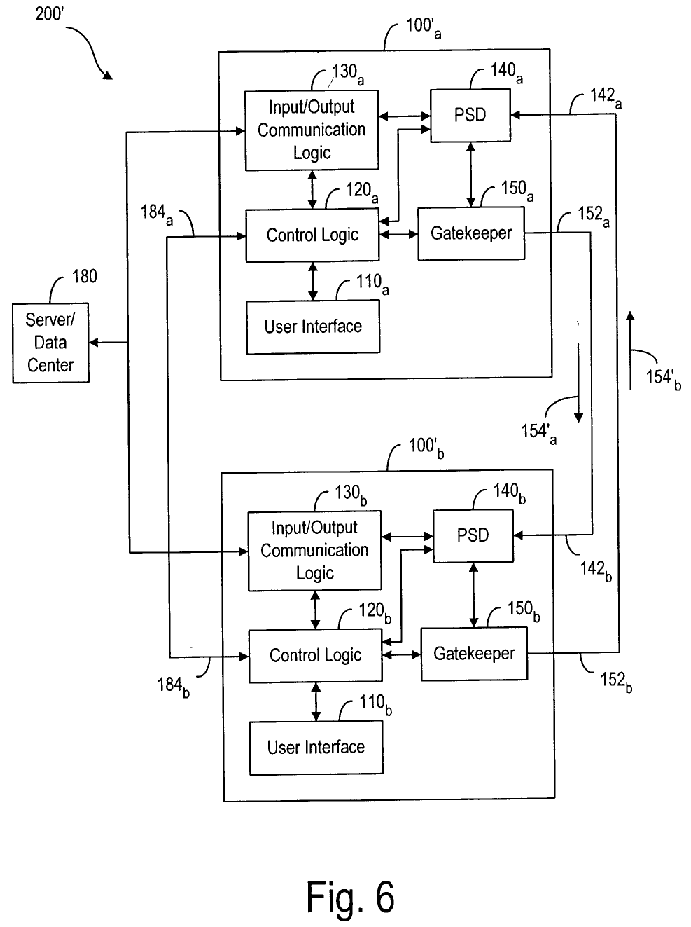

The method of fund transfers between postal meters 100, according to the present invention, is applicable to a hand-held metering unit 100′ (without a printing mechanism) whether the hand-held metering unit is linked to a regular postal meter 100 (with a printing mechanism) or another hand-held metering unit 100′. FIG. 6 illustrates the connection between two hand-held metering units 100′. Either metering unit 100′ can be a recipient while the other can be the donor. For example, if the metering unit 100′a is the donor, then funds 154′a can be transferred from the gatekeeper 150′a to the PSD 140′b. Likewise, if the metering unit 100′b is the donor, the funds 154′b can be transferred from the gatekeeper 150′b to the PSD 140a′. Either metering unit can be linked to the data center 180 for fund transfer between the data center and the requesting metering unit.

It should be noted that the postal meter 100, as illustrated in FIG. 2, is only a special embodiment of the secure device of the present invention. A generalized secure device, according to the present invention, is shown in FIG. 7. In a postal meter 100, the general function of the PSD 140 is to dispense and account for postal value stored therein to pay for the postage indicia. In that respect, the PSD 140 is a safekeeping module. The general function of the gatekeeper 150 is to secure the communication between the PSD 140 and the printing mechanism 160 of the same postal meter 100 or the PSD 140 of a recipient postal meter 100. The gatekeeper 150 can be referred to as a secure communication module. Likewise, the printing mechanism 160 is a type of output device. Thus, instead of having a PSD 140, a gatekeeper 150 and a printing mechanism 160, the generalized secure device 100″, as shown in FIG. 7, comprises a safekeeping module 140″, a secure communication module 150″ and an output device 160″. In addition to transferring funds, the secure device 100″ can also be used to transfer secure information. Analogous to the printing mechanism 160 in a postal meter 100, the output device 160″ can be used to display secure information upon receiving a request made by a customer using the user interface 110″. Secure information can be transferred from the safekeeping module 140″ through the secure communication module 150″ of a “donor” secure device 100″ to the safekeeping module 140″ of a “recipient” secure device 100″. The transaction between a “donor” secure device 100″ and a “recipient” secure device 100″ is similar to the transaction between a donor meter 100 and a recipient meter 100 as described in conjunction with FIG. 3a. The method of secure transaction, as illustrated in FIG. 5, is also applicable to the secure device 100″ if the term “fund” in blocks 440 and 450 of flowchart 400 is replaced by “secure information”.

Thus, although the invention has been described with respect to a preferred embodiment thereof, it will be understood by those skilled in the art that the foregoing and various other changes, omission and deviations in the form and detail thereof may be made without departing from the scope of this invention.

What is claimed is:

1. A method of transferring funds between postal metering systems, wherein at least a first postal metering system and a second postal metering system each comprises:
a safekeeping device for storing and releasing funds;
a secure communication device for ensuring that communications with the safekeeping device are secure;
an input/output communication module, operatively connected to the safekeeping device, to allow funds to be transferred from a data center to the safekeeping device via the input/output communication module; and
a control device, operatively connected to the secure communication device, for causing a release of funds by the safekeeping device through the secure communication device when the control device receives a request for said fund release, said method comprising the step of:
providing an external communication link from the first postal metering system to the second postal metering system; and
transferring funds through the external communication link from the second postal metering system from its secure communication device to the safekeeping device of the first postal metering system.

2. The method of claim 1, wherein said fund transfer through the external communication link is in response to a request made at the control device of the first postal metering system.

3. The method of claim 2, further comprising the steps of:
sending a request of said fund transfer through the external communication link, said request conveyed from the control device of the first postal metering system to the control device of the second postal metering system; and
granting said request by the second postal metering system.

4. The method of claim 3, further comprising the steps of:
conveying a first signal from the control device of the second postal metering system to the control device of the first postal metering system indicative of said granting; and
conveying a second signal from the control device of the first postal metering system to the control device of the second postal metering system acknowledging receipt of the first signal, thereby causing said fund transfer through the external communication link.

5. The method of claim 1, wherein said fund transfer through the external communication link is in response to a request made at the control device of the second postal metering system.

6. The method of claim 5, further comprising the steps of:
conveying a first signal from the control device of the second postal metering system to the control device of the first postal metering system notifying said fund transfer through the external communication link; and
conveying a second signal from the control device of the first postal metering system to the control device of the second postal metering system acknowledging receipt of the first signal, thereby causing said fund transfer through the external communication link.

7. The method of claim 1, wherein the external communication link comprises a wireless communication link.

8. The method of claim 1, wherein the postal metering systems further comprises at least a third metering system, which comprises:
a safekeeping device for storing and releasing funds; and
a secure communication device for ensuring that communications with the safekeeping device are secure, said method further comprising the steps of:
providing a further external communication link from the second postal metering device to the third metering,system; and
transferring funds through the further external communication link from the second postal metering device from its secure communication device to the safekeeping device of the third metering system.

9. The method of claim 8, wherein the further external communication link comprises a wireless communication link.

10. The method of claim 1, wherein the safekeeping device also stores secure information and the control device is capable of causing a release of information by the safekeeping device through the secure communication device through the external communication link.

11. A postal metering system comprising:
a safekeeping device for storing and releasing funds;
a secure communication device for ensuring that communications with the safekeeping device are secure;
an input/output communication module, operatively connected to the safekeeping device, to allow funds to be transferred from a data center to the safekeeping device via the input/output communication module; and
a control device, operatively connected to the secure communication device, for causing the safekeeping device to release funds through the secure communication device when the control device receives a request for said fund release, wherein the safekeeping device further comprises an external communication link so as to allow the postal metering system to receive funds from another postal metering system via the secure communication device thereof through the external communication link.

12. A secure system comprising:
a safekeeping device for storing and releasing secure information;
a secure communication device for insuring communications with the safekeeping device are secure;
an input/output communication module, operatively connected to the safekeeping device, to allow secure information to be transferred from a data center to the safekeeping device; and
a control device, operatively connected to the secure communication device, for causing a release of secure information by the safekeeping device through the secure communication device upon receiving a request for said fund release, wherein the safekeeping device further comprises an external communication link so as to allow the secure system to receive secure information from another secure system via the secure communication device thereof through the external communication link.
